(19) United States
(12) Patent Application Publication
(10) Pub. No.: US 2010/0104783 A1
(43) Pub. Date: Apr. 29, 2010

(54) RESIN COMPOSITION USED FOR HEAT-SHRINKABLE MEMBER, HEAT-SHRINKABLE TUBE COMPOSED OF THE RESIN COMPOSITION, AND MEMBER COVERED BY THE TUBE

(75) Inventors: Asami Kitajima, Shiga (JP); Motoi Yamashita, Shiga (JP); Takashi Hiruma, Shiga (JP); Hirotsugu Fujita, Shiga (JP); Jun Takagi, Shiga (JP)

Correspondence Address: DARBY & DARBY P.C., P.O. BOX 770, Church Street Station, New York, NY, 10008-0770, US

(73) Assignee: Mitsubishi Plastics, Inc., Tokyo (JP)

(21) Appl. No.: 12/530,951

(22) PCT Filed: Mar. 14, 2008
(86) PCT No.: PCT/JP2008/054759

§ 371 Date: Dec. 16, 2009

(30) Foreign Application Priority Data
Mar. 15, 2007 (JP) 2007-067342

(51) Int. Cl. B32B 1/08; C08L 81/04; C08K 5/52

(52) U.S. Cl. 428/35.1; 524/609; 524/140

(57) ABSTRACT

A resin composition used for a heat-shrinkable member: at least one plasticizer; and a polyphenylene sulfide resin (a), at least one tan δ peak existing within the temperature range between 65 and 95° C. as measured by dynamic viscoelasticity at an oscillation frequency of 10 Hz, a strain of 0.1%, and a temperature increase rate of 3° C./min.

### CROSS REFERENCE TO RELATED APPLICATIONS

This is the U.S. national phase application under 35 U.S. U.S.C. §371 of International Patent Application No. PCT/JP2008/054759 filed Mar. 14, 2008 and claims the benefit of Japanese Application No. 2007-067342 filed Mar. 15, 2007, both of which are hereby incorporated by reference in their entireties. The International Application was published on Sep. 25, 2008 as International Publication No. WO 2008/114731 under PCT Article 21(2), and.

### FIELD OF THE INVENTION

The present invention relates to a resin composition used for heat-shrinkable members, a heat-shrinkable tube comprised of the resin composition, and a member covered by the tube. More particularly, the invention relates to a resin composition which shrinks at low temperatures when formed into a heat-shrinkable member and which is thereby suitably used for a heat-shrinkable member for covering electronic parts, and in particular, capacitors including aluminum electrolysis capacitors as well as primary batteries and secondary batteries. The invention also relates to a heat-shrinkable tube comprised of the resin composition, and a member covered by the tube.

### BACKGROUND OF THE INVENTION

Conventionally, as electric insulating materials used for coating capacitors and so on, polyvinyl chloride and polyethylene terephthalate have been widely used. In recent years, electronic parts like capacitors have become highly densified due to the demand of lighter and more compact parts. Meanwhile, fields of parts like auto electronic components which are exposed to a high-operating temperature are also rapidly expanding. In these fields, various products, which are covered by the heat-shrinkable members mainly for the purpose of electrical insulation, have been developed.

A heat-shrinkable member composed of polyvinyl chloride shows excellent flame retardancy. However, thermal resistance is insufficient, and environmental issues due to its waste disposal are problematic. A heat-shrinkable member composed of polyester resin such as polyethylene terephthalate exhibits excellent thermal resistance. However, flame retardancy is not sufficient. From the above points, when a heat-shrinkable member is used as an electrical insulation material, a heat-shrinkable member which satisfies flame retardancy and thermal resistance at the same time is demanded.

Conventionally, polyphenylene sulfide resin has been known as a material which satisfies both flame retardancy and thermal resistance at the same time. The polyphenylene sulfide resin is an excellent material which satisfies properties including not only flame retardancy and thermal resistance, but also electric properties, chemical resistance, electrolyte resistance, and so on. A heat-shrinkable tube using polyphenylene sulfide resin by focusing on these properties is known (See Japanese Patent Application Laid-Open (JP-A) No. 09-157402, which is hereby incorporated by reference herein in its entirety.). However, the tube obtained by the method of the '402 application cannot respond to the recent circumstances such that, for the purpose to improve productivity, speed for covering tube on capacitor, for example, tends to become faster and heating required for covering tends to be carried out at high temperature and within a short time.

### SUMMARY OF THE INVENTION

Accordingly, an object of the present invention is to provide a resin composition used for a heat-shrinkable member that exhibits excellent shrinkage properties at low temperature, and that satisfies properties required for the heat-shrinkable members such as flame retardancy, thermal resistance, electric properties, chemical resistance, and electrolyte resistance.

Another object of the present invention is to provide a heat-shrinkable tube comprised of the resin composition of the present invention showing the above properties, and to provide a member covered by the tube and a member used for electronic parts.

In order to solve the above problems, the present inventors seriously studied the properties of polyphenylene sulfide resin. As a result, the inventors discovered a resin composition which can be used for a heat-shrinkable member, wherein the composition satisfies various properties required for a heat-shrinkable member such as flame retardancy and thermal resistance and also exhibits excellent shrinkage property at low temperature.

More specifically, the object of the present invention can be attained by a resin composition (hereinafter, refer to as “resin composition of the invention”) used for a heat-shrinkable member, which comprises: at least one plasticizer; and a polyphenylene sulfide resin (a), at least one tan δ peak existing within the temperature range between 65 and 95° C. as measured by dynamic viscoelasticity at an oscillation frequency of 10 Hz, a strain of 0.1%, and a temperature increase rate of 3° C./min.

In the resin composition of the invention, at least one plasticizer is preferably a flame-retardant plasticizer or a phosphorus-based plasticizer.

In the resin composition of the invention, a content ratio of at least one plasticizer, to the total mass of the resin composition, is desirably 0.5 mass % or more and 15 mass % or less.

The resin composition can further contains the resin (b) other than the polyphenylene sulfide resin (a) and/or the thermoplastic elastomer (c) such that content ratio of the resin (b) and/or the thermoplastic elastomer (c), to the total mass of the resin composition, is 0.1 mass % or more and 35 mass % or less.

Another object of the present invention can be attained by a heat-shrinkable tube (hereinafter, referred to as the “tube of the invention”) comprising by the resin composition of the present invention, by a member covered by the heat-shrinkable tube, and by members used for electronic devices or electric appliances.

The tube of the invention is preferably formed such that the shrinkage ratio in the longitudinal direction is 2% or more and 20% or less and shrinkage ratio in the diameter direction is 10% or more and 60% or less as measured after immersing the tube in hot water of 90° C. for 5 seconds. The tube is more preferably formed such that the shrinkage ratio in the longitudinal direction is 15% or less and shrinkage ratio in the diameter direction is 10% or more and 60% or less as measured after immersing the tube in hot water of 80° C. for 5 seconds.

The present invention provides a heat-shrinkable member which exhibits excellent shrinkage property at low temperature, and which satisfies properties required for the heat-shrinkable member such as flame retardancy, thermal resistance, electric properties, chemical resistance, and electrolyte resistance. Therefore, as an alternative member to the conventional vinyl chloride-based heat-shrinkable member and polyester-based heat-shrinkable member, the present invention is useful for covering electronic parts such as capacitors, primary batteries, and secondary batteries, or for covering members of electric appliances such as steel tubes (pipes) or motor coil-ends, and electrical transformer.

### DETAILED DESCRIPTION OF THE INVENTION

Hereinafter, the resin composition, the heat-shrinkable tube, and the member covered by the heat-shrinkable tube of the invention will be described in detail.

[The Resin Composition of the Present Invention]

The resin composition includes: at least one plasticizer; and a polyphenylene sulfide resin (a), at least one tan δ peak existing within the temperature range between 65 and 95° C. as measured by dynamic viscoelasticity at an oscillation frequency of 10 Hz, a strain of 0.1%, and a temperature increase rate of 3° C./min.

<Thermoplastic Polyphenylene Sulfide Resin (a)>

The thermoplastic polyphenylene sulfide resin (a) used in the present invention is a resin in which repeating unit of the polyphenylene sulfide of the following formula (I) (hereinafter, refer to as “PPS”.) is contained at an amount of 70 mol % or more, preferably 80 mol % or more. When the below-described repeating unit of the PPS resin is 70 mol % or more, decrease of both crystallization and temperature of thermal transformation of the polymer can be inhibited. Various properties like flame retardancy, chemical resistance, and electric properties, which are the characteristics of the resin composition containing PPS resin as the main component, can also be inhibited.

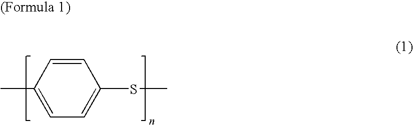

About the above PPS resin (a), copolymerizable other units having sulfide bond may be included under the condition where the content is below 30 mol %, preferably below 20 mol %. Examples of copolymerizable other repeating units include: aryl units, biphenyl units, terphenylene units, vinylene units, carbonate units, and so on, each of these having a substituent such as a meta-bond unit, an ortho-bond unit, a trifunctional unit, an ether unit, a ketone unit, a sulfone unit, and an alkyl group. These units may be used alone, or may be used in combination of two or more thereof. In this respect, these structural units may be any of copolymerization types, like random types or block types.

The above PPS resin (a) is, but not restricted to, preferably a linear polymer having a molecular mass of 50,000 or more; it may be a branched polymer or a partly-crosslinked polymer.

The PPS resin (a) may contains a low-molecular-mass oligomer. In this respect, a content ratio of the low-molecular-mass oligomer is preferably about 1.5 mass % or less in view of resistance to thermal deterioration and mechanical strength. The molecular mass of the low-molecular-mass oligomer is 100 or more and 2,000 or less. The low-molecular-mass oligomer contained in the PPS resin can be removed by washing with solvent such as diphenyl ether.

Melt viscosity of the PPS resin (a) is not specifically restricted as long as a heat-shrinkable member which satisfies predetermined properties can be obtained; the apparent viscosity as measured at 300° C., a shear rate of 100 sec⁻¹, an orifice L/D=10/1 (mm), is 100 Pa·s or more, preferably 200 Pa·s or more, more preferably 400 Pa·s or more, and 10,000 Pa·or less, preferably 5,000 Pa·s or less, more preferably 2,000 Pa·s or less. When the apparent viscosity is 100 Pa·s or more, film making can be performed. On the other hand, when the apparent viscosity is 10,000 Pa·s or less, it is capable of lower the load to the extruder during extrusion.

A method for manufacturing the PPS resin (a) may be any kind of known method so that it is not specifically limited. An example of a generally used method is a method by reacting a dihalogenated aromatic compound such as p-dichloro benzene and a sodium salt such as sodium sulfide in an aprotic organic solvent like N-methyl-2-pyrrolidone (hereinafter, refer to as “NMP”) so as to adjusting degree of polymerization, by adding a polymerization aid like a caustic alkali or an alkali metal salt of carboxylic acid. The reaction is preferably carried out at a temperature between 230 and 280° C. Pressure in the polymerization system and polymerization duration is adequately determined depending on desired degree of polymerization as well as types and amount of polymerization aid to be used.

Nevertheless, by the above method, sodium halide is produced as a by-product. Since the sodium halide is not dissolved with a solvent like NMP, it is incorporated in the resin. Hence, the sodium halide in the PPS resin cannot be sufficiently removed even if the PPS resin is washed after polymerization by a large quantity of water. So, alternatively, a method of polymerization can be carried out by using lithium salt instead sodium salt.

<Plasticizer>

The resin composition used in the present invention contains at least one plasticizer. Examples of plasticizer suitable for use in the invention include: various known plasticizers such as a phthalic acid ester-based plasticizer, a tetrahydrophthalic acid ester-based plasticizer, a trimellitic acid ester-based plasticizer, an adipic acid ester-based plasticizer, a sebacic acid ester-based plasticizer, a phosphate ester-based plasticizer, a citric acid ester-based plasticizer, a polyester-based plasticizer, an epoxy-based plasticizer, lactam-based plasticizer, a sulfonamide-based plasticizer, a glycolic acid-based plasticizer, a paraffinic mineral oil, a naphthenic mineral oil, a polyolefin, and a polysiloxane. Among these, a flame-retardant plasticizer including a phosphate ester-based plasticizer is preferable because it does not impair flame retardancy as a characteristic of the PPS resin (a). When considering the extrusion temperature, i.e. between 280 and 320° C., of the PPS resin (a), a plasticizer whose boiling point and decomposition temperature is 400° C. or more is preferable. Preferred examples of phosphate ester-based plasticizers include: triphenyl phosphate, tricresyl phosphate, and trixylenyl phosphate. By using these plasticizers, a glass-transition temperature of the resin can be lowered without impairing excellent flame retardancy of the PPS resin (a). Good shrinkage properties at low temperatures are thereby imparted to the resin.

The content ratio of at least one plasticizer to the total mass of the resin composition is 0.5 mass % or more, preferably 1 mass % or more, more preferably 3 mass % or more, and it is 15 mass % or less, preferably 10 mass % or less, more preferably 7 mass % or less. When the content ratio of plasticizer is 0.5 mass % or more, not only can a plasticizing effect be obtained, but also good shrinkage properties at low temperature and effects for inhibiting a whitening of resin composition can be obtained. On the other hand, when the content ratio is 15 mass % or less, melt viscosity is not excessively reduced so that degradation of thickness accuracy can be inhibited.

<The Resin (b) Other than PPS Resin and the Elastomer (c)>

The resin composition of the present invention may be composed of PPS resin (a) alone, or may be composed by blending the other resins (b) and the elastomer (c), etc. and alloying thereof. Examples of the other resins (b) for the use of blending and alloying include: polyester, liquid-crystal polymer, polyamide, polycarbonate, polyolefin, polystyrene, ABS resin, imide-modified ABS resin, AES resin, polyphenylene ether, a copolymer and/or mixture of polyphenylene ether and polystyrene, polyimide, polyamide-imide, polyarylate, polyether imide, polyether ether ketone, polyether sulfone, and polysulfone. By blending and alloying with these resins, effects like enhancing adhesiveness between different members (e.g. PPS resin (a) and ink) can be obtained.

On the other hand, examples of the elastomer (c) include: polyester-based, polyamide-based, polyurethane-based, and olefin-based copolymer; thermoplastic elastomers such as polystyrene-based elastomer; nitrile-based rubber; and acrylic rubber. Specifically, there may be: butadiene copolymer, styrene-isoprene copolymer, butadiene-styrene copolymer (copolymer of each random, block, and graft), isoprene copolymer, chlorobutadiene copolymer, butadiene-acrylonitrile copolymer, isobutylene copolymer, isobutylene-butadiene copolymer, isobutylene-isoprene copolymer, ethylene-propylene copolymer, and ethylene-propylene-diene copolymer. Moreover, partly-modified rubber components can be used; for example, partially hydrogenated styrene-butadiene block copolymer and partially-hydrogenated styrene-isoprene block copolymer. By blending and alloying the PPS resin (a) and these elastomers (c), impact strength of the resin compositions and the like are enhanced.

A content ratio of the other resins (b) and/or the elastomer (c) these of which are mixed with the PPS resin (a), to the total mass of the resin composition, is desirably 0.1 mass % or more, preferably 1 mass % or more, more preferably 5 mass % or more, 35 mass % or less, preferably 20 mass % or less, more preferably 15 mass % or less. When the content ratio of the other resins (b) and/or the elastomer (c) these of which are mixed with the PPS resin (a) is too low, the additive effect cannot be expected; when the content ratio thereof is too high, characteristics of the PPS resin (a) like flame retardancy are possibly deteriorated.

To the resin composition of the present invention, in order to improve slidability of the heat-shrinkable member, organic lubricant, inorganic lubricant, and inorganic filler can be added; as required, to the degree which does not deteriorate the properties of the invention, auxiliaries such as a stabilizer, coloring agent, antioxidant, and ultraviolet absorber can be blended. In addition to these, to the tube of the present invention, corona discharge treatment, flame treatment, printing, embossing, and so on may be applied for various purposes.

<Tan δ Peak of the Resin Composition>

In the resin composition of the present invention, at least one tan δ peak, which is a ratio of a storage elastic modulus (E′) and a loss elastic modulus (E″) as measured by dynamic viscoelasticity at an oscillation frequency of 10 Hz, a strain of 0.1%, and a temperature increase rate of 3° C./min, exists within the temperature range between 65 and 95° C. When the tan δ peak exists within the above range, the resin composition of the invention attains shrinkage property at low temperature when it is formed into a heat-shrinkable member. Accordingly, it can be suitably used, for example, for a heat-shrinkable tube for covering material of capacitors and batteries. If a temperature of the tan δ peak position becomes below 65° C. or over 95° C., thickness accuracy tends to be deteriorated in the stretching process of the method for manufacturing the heat-shrinkable member. Setting the tan δ-peak existing temperature range to the above range is possible by adequately adjusting the amount of plasticizers and a combination of resins to be used. For instance, the shift of tan δ peak position to a low-temperature side (side of 65° C.) can be attained by increasing an additive amount of plasticizer. On the other hand, the shift of tan δ peak position to a high-temperature side (side of 95° C.) can be attained by reducing the additive amount of plasticizer. Alternatively, in the case where temperature of tan δ peak position of the resin composition is adjusted by the addition of the other resins (b) and/or the elastomer (c), the tan δ peak can be shifted to a high-temperature side by adding a resin having a tan δ peak within a higher temperature range than the temperature of the tan δ peak of the PPS resin (a) itself. The tan δ peak can be shifted to a low-temperature side by adding a resin having a tan δ peak within a lower temperature range than the temperature of the tan δ peak of the PPS resin (a) itself.

After forming the resin composition into a heat-shrinkable member, the tan δ peak can be measured by using a viscoelastic spectrometer (for example, type DVA-200 produced by IT Measurement Co., Ltd.) under conditions at an oscillation frequency of 10 Hz, a strain of 0.1%, a measurement temperature range between −50 and 300° C., and a temperature increase rate of 3° C./min.

<Method for Manufacturing the Resin Composition of the Present Invention>

The resin composition according to the present invention can be produced by using conventional known manufacturing methods. For example, the method may include the steps of: preliminarily adding a plasticizer and the PPS resin (a), the other resins (b) and/or the elastomer (c), and optionally other additives as required; feeding the obtained mixture into a conventional melt-mixing machine such as a monoaxial or a biaxial extruder, a tumbler, a V-blender, a Banbury mixer, a kneader, and mixing rolls; and then kneading the above mixture at a temperature between 180 and 450° C. Alternatively, each of the measured components may be separately fed into the corresponding two or more feed-openings of an extruder. The mixing order of the base materials is not restricted. There are several methods of mixing: a method by directly mixing the various plasticizers and additives with the PPS resin (a) to be used and then melt-mixing thereof; a method by first preparing a master batch in which various plasticizers and additives are mixed with the PPS resin (a) at a high degree of concentration (typical content is about 50-60 mass %) and mixing the master batch with the PPS resin (a) while adjusting the concentration; a method by melt-mixing a part of the base material using the above method and further melt-mixing the rest of the base material; or a method by mixing a part of the base material in a monoaxial or a biaxial extruder while mixing the rest of the base material using a side feeder. Any of these methods can be used. Moreover, for a small-quantity of additive components, after mixing other components by the above methods and so on and palletizing the obtained mixture, the additive can be added before molding to obtain a molded product.

The resin composition of the invention exhibits excellent shrinkage properties at low temperature, as well as flame retardancy, thermal resistance, good electric properties, chemical resistance, and electrolyte resistance. Therefore, the resin composition of the invention can be suitably used, for example, for a heat-shrinkable member such as a heat-shrinkable film, a heat-shrinkable sheet, and a heat-shrinkable tube, particularly the heat-shrinkable tube.

[Heat-Shrinkable Tube of the Present Invention]

Next, the heat-shrinkable tube of the present invention will be described as follows.

The heat-shrinkable tube of the invention comprises the resin composition of the present invention. For example, the tube of the invention comprises the resin composition including at least one plasticizer and the PPS resin (a); whereby the tube having a particular thermal shrinkability exhibits excellent performance as a covering material specifically for capacitors and batteries.

For the heat-shrinkable tube of the invention, a shrinkage ratio in the longitudinal direction, as measured after immersing the tube in hot water of 90° C. for 5 seconds, is within the range of 2% or more, preferably 3% or more, more preferably 5% or more, and 20% or less, preferably 15% or less, more preferably 12% or less. Meanwhile, the shrinkage ratio in the diameter direction as measured under the same conditions is within the range of 10% or more, preferably 15% or more, more preferably 20% or more, and 60% or less, preferably 50% or less, more preferably 45% or less.

In addition, for the heat-shrinkable tube of the invention, the shrinkage ratio in the longitudinal direction, as measured after immersing the tube in hot water of 80° C. for 5 seconds, is within the range of 15% or less, preferably 12% or less, more preferably 10% or less. Meanwhile, the shrinkage ratio in the diameter direction as measured under the same conditions is within the range of 10% or more, preferably 15% or more, more preferably 20% or more, and 60% or less, preferably 50% or less, more preferably 45% or less.

When the shrinkage ratio in the longitudinal direction as measured after immersing the tube in hot water of 90° C. for 5 seconds is 20% or less, problems like misalignment of covering position due to excessive shrinkage in the longitudinal direction when covering of electric parts as well as lengthening of the cutting length can be inhibited. Moreover, when the shrinkage ratio in the diameter direction when immersing the tube in hot water of 90° C. for 5 seconds is 10% or more, sufficient shrinkage to cover the parts can be obtained. Particularly, the shrinkage ratio in the longitudinal direction as measured after immersing in hot water of 80° C. for 5 seconds is 15% or less and the shrinkage ratio in the diameter direction as measured under the same condition is 10% or more, shrinkable property at low-temperature can be obtained. The tube can thereby be suitably used for a covering member for electronic devices and electric appliances, which are difficult to be treated at high temperature.

Further, for the heat-shrinkable tube, the shrinkage ratio in the longitudinal direction, as measured after immersing the tube in boiling water for 5 seconds, is within the range of 30% or less, preferably 25% or less, more preferably 20% or less; shrinkage ratio in the diameter direction as measured under the same conditions is preferably within the range of 20% or more, preferably 25% or more, more preferably 30% or more, and 70% or less, preferably 60% or less, more preferably 50% or less. In view of inhibiting problems associated with covering position, cutting length and so on, the lower limit of the shrinkage ratio in the longitudinal direction in the boiling water is preferably low, it is desirably about 5%.

When the tube satisfies the above heat-shrinkable properties, preferably a heat-shrinkable property in hot water of 80° C., hot water of 90° C., and boiling water, cover appearance is favorable and the tube can be shrunk at a low temperature when covering an object. So, it is capable of saving energy cost and of covering by using a conventional covering machine under almost the same covering conditions as that of conventional tubes. It should be noted that the shrinkage ratio is a shrinkage ratio which can be obtained when immersing in boiling water or hot water for 5 seconds. Formerly, for a similar evaluation, there was a case using a shrinkage ratio as measured after immersing in hot water for 30 seconds. However, when improving productivity, the speed of the step for covering the tube onto the capacitor and so on becomes faster and heating required for covering tends to be performed at a higher temperature within a shorter time so that it is difficult to meet the conventional measuring time and actual production step. Therefore, the above condition is provided.

The above heat-shrinkable property can be obtained by adequately adjusting the additive amount of plasticizers, the temperature for stretching the tube, and so on. For example, increasing the shrinkage ratio in the longitudinal direction to the upper limit (20%) side can be attained by raising the ratio between a feeding speed of a non-elongated tube and a nip-roll speed after elongation. The shrinkage ratio to the lower limit (2%) side can be decreased by reducing the ratio between the feeding speed of the non-elongated tube and the nip-roll speed after elongation. On the other hand, increasing the shrinkage ratio in the diameter direction to the upper limit (60%) side can be attained by raising the ratio between the diameter of the non-elongated tube and the diameter of the elongated tube. The shrinkage ratio to the lower limit (10%) side can be decreased by reducing the ratio between the diameter of the non-elongated tube and the diameter of the elongated tube.

The method for manufacturing the tube of the present invention will be described as follows. The method for manufacturing the tube of the present invention is not specifically limited; a preferred method may include the steps of: extruding a non-elongated tube normally by using round dies and then elongating the extruded tube to obtain a seamless heat-shrinkable tube. Apart from this, there are other examples such as a method by adhering, by fusion-bonding, weld-bonding, or gluing, a film obtained by extrusion using T-dies or I-dies and elongation, and a method by adhering the tube or the film in a spiral form to form a tube.

Here, the method in which a non-elongated tube is extruded by using the round dies and then the extruded tube is elongated to form a heat-shrinkable tube, will be more specifically described. The resin composition is heated by a melt-extruding apparatus up to a temperature of the melting point or more and melted; then, the melted resin is continuously extruded from the round dies and forcibly cooled to form a non-elongated tube. As a method of forcible cooling, there may be immersion in cold water or cooling with chilled, forced air. Among these, the method by immersing in cold water shows high cooling efficiency so that it is advantageous. The obtained non-elongated tube may be continuously provided to the following elongation step, or it may be once wound with a roll and then used as the original tube in the elongation step. In view of productivity and thermal efficiency, a method in which the non-elongated tube is continuously provided to the following elongation step is preferable.

The non-elongated tube thus obtained is pressurized by a compressed gas from the inner side of the tube, and then it is elongated. The elongation method is not specifically limited. For example, there is a method by applying pressure of the compressed gas from one end of the non-elongated tube and discharging the pressure from the other end at a constant rate, followed by heating the tube by hot water or infrared heater, and then letting the tube into a cooled cylinder for controlling elongation magnification in the diameter direction to complete elongation of fixed magnification. The temperature condition is adjusted such that the tube is elongated at a certain position of the cylinder. The elongated tube cooled in the cylinder is wound as an elongated tube while being held by a pair of nip rolls. Order of the elongation in the longitudinal direction and the diameter direction is not restricted, and elongation in these directions is preferably carried out at the same time.

An elongation magnification in the longitudinal direction is determined based on the ratio between the feeding speed of the non-elongated tube and nip-roll speed of the elongated tube. The elongation magnification in the diameter direction is determined based on the ratio between diameter of the non-elongated tube and diameter of the elongated tube. Another pressure elongation method apart from this may be a method by holding both feeding side of non-elongated tube and drawing side of the elongated tube between nip rolls and then keeping the internal pressure of the enclosed compressed gas.

The conditions of elongation are adjusted by properties of the resin composition to be used or the targeted heat-shrinkage ratio, in the tube of the invention, since the number of the tan δ peak as measured by dynamic viscoelasticity measurement at an oscillation frequency of 10 Hz, a strain of 0.1%, and a temperature increase rate of 3° C./min is at least one within the range of 65° C. or more and 95° C. or less. Elongation is carried out within a temperature range of the glass-transition temperature or more and 100° C. or less, preferably 65° C. or more and 95° C. or less.

The tube of the invention is obtained by preferably elongating a non-elongated tube: in the diameter direction at a magnification of 1.2 times or more, preferably 1.3 times or more, more preferably 1.4 times or more and 3.0 times or less, preferably 2.5 times or less, more preferably 2.0 times or less; and in the longitudinal direction at a magnification of 1.0 time of more, preferably 1.02 times or more and 2.0 times or less, preferably 1.5 times or less, more preferably 1.3 times or less. When the elongation magnification of the tube in the diameter direction is 1.2 times or more, amount of shrinkage sufficient enough to cover the object can be obtained. When the elongation magnification of the tube is 3.0 times or less, an increasing tendency of unevenness in thickness can be inhibited and a decrease of the shrinkage ratio due to the oriented crystallization can be inhibited. On the other hand, when the elongation magnification of the tube in the longitudinal direction is 2.0 times or less, a misalignment of the covering position of the electric parts and so on due to the excessive shrinkage in the longitudinal direction can be inhibited and an increase in cost caused by unnecessary lengthening of the cutting length of the tube can be inhibited.

A thickness of the tube thus obtained is not specifically limited. The thickness of the tube generally used for capacitors, depending on rated voltage, is within the range of about 0.05 mm to 1.0 mm, typically within the range of 0.07 mm to 0.2 mm. Moreover, a tube whose width in a folded state (hereinafter, refer to as “folding diameter”.) is in the range of 4 mm to 300 mm is preferable, as it can be used for covering of general-purpose capacitors and batteries as well for overall packaging of a general-purpose battery.

The tube of the present invention can be suitably used as a cover material for capacitors such as aluminum electrolytic capacitors. It is also useful for other applications like covering tubes for electric cables (round cable, flat cable), dry-cell batteries, secondary batteries such as lithium-ion batteries, steel pipes or motor coil ends, electric appliances like electrical transformers or compact motors, or electric bulbs, fluorescent tubes, and fluorescent tubes of facsimile and image scanners.

### EXAMPLES

The present invention will be more specifically described by way of the following examples; however, the invention is not restricted by them. Various measured values and evaluations about the heat-shrinkable tube shown in this description were determined as below.

(1) Tan δ Peak Temperature

A temperature of the tan δ peak is a value obtained by measuring a test piece having a coating of resin composition of the present invention (100 μm thick, 0.412 cm wide, 2.5 cm in inter-marker distance) in the tube's length direction by using viscoelastic spectrometer (for example, type DVA-200 produced by IT Measurement Co., Ltd.). The measurement was carried out under conditions at an oscillation frequency of 10 Hz, a strain of 0.1%, a measurement temperature range between −50 and 300° C., and a temperature increase rate of 3° C./min.

(2) Shrinkage Ratio of the Heat-Shrinkable Tube

A length and folded diameter of the heat-shrinkable tube before and after immersing for 5 seconds in hot water at 80° C. and 90° C., as well as boiling water were measured and the shrinkage ratio was calculated by the following expressions.

(Shrinkage ratio in the longitudinal direction [%])={[(length of tube before immersing)−(length of tube after immersing)]/(length of tube before immersing)}×100

(Shrinkage ratio in the diameter direction [%])={[(folded diameter of tube before immersing)−(folded diameter of tube after immersing)]/(folded diameter of tube before immersing)}×100

(3) Flame Retardancy

A flame retardancy of the heat-shrinkable member obtained by the resin composition of the present invention was evaluated in accordance with UL224 Optional VW-1 Flame Test adopted as a flame retardancy evaluation.

(4) Thermal Resistance

An aluminum electrolytic capacitor having a diameter of 35 mm and a length of 59.5 mm was covered by a tube having a folded diameter of 59 mm, a thickness of 0.1 mm, and a length of 73 mm in a circulating hot air shrink oven at 200° C. for 5 seconds. After aging in the hot air oven at 85° C. for 60 minutes, the set of the aluminum electrolytic capacitor and the tube was again exposed under an atmosphere in the hot air oven at 200° C. for 5 minutes. Cracks of the resultant were evaluated based on the following criteria.

∘: no crack occurs (good thermal resistance).

x: cracks occur (bad thermal resistance).

<Materials to be Used>

Materials to be used for the Examples of the resin composition of the present invention, Comparative examples, and Reference examples are shown as follows.

PPS1: polyphenylene sulfide resin [commodity name: FORTRON 0220C9 manufactured by Polyplastics Co., Ltd., apparent viscosity (300° C., shear rate of 100 sec⁻¹): 510 Pa·s]

PPS2: polyphenylene sulfide resin [commodity name: FORTRON 0316C1 manufactured by Polyplastics Co., Ltd., apparent viscosity (300° C., shear rate of 100 sec⁻¹): 330 Pa·s]

Resin 1: polyamide resin (commodity name: NOVAMID X21 manufactured by Mitsubishi Engineering-Plastics Corporation)

Resin 2: polycarbonate resin (commodity name: IUPILON 52000 manufactured by Mitsubishi Engineering-Plastics Corporation)

ESM1: acid modified SEBS resin (commodity name: TUFTEC M1943 manufactured by Asahi Kasei Chemicals Corporation)

ESM2: modified SEBS resin (commodity name: DYNARON 8630P manufactured by JSR Corporation)

ESM3: SEPS resin (commodity name: SEPTON 2063 manufactured by Kuraray Co., Ltd.)

Plasticizer 1: triphenyl phosphate (commodity name: TPP manufactured by Daihachi Chemical Industry Co., Ltd.)

### Examples 1 to 10 and Comparative Examples 1 to 4

A resin composition having contents shown in Table 1 was melted by an extruder whose cylinder temperature was set at 290° C. and the melted resin was formed into a tube through round dies to obtain a heat-shrinkable polyphenylene sulfide-based tube having a folded diameter of 59 mm and a thickness of 0.1 mm. In the Comparative example 3, properties of the heat-shrinkable tube were evaluated by using a polyethylene terephthalate heat-shrinkable tube (commodity name: HISHI TUBE T22 manufactured by Mitsubishi Plastics, Inc.; a folded diameter of 58 mm, a thickness of 0.11 mm). In the Comparative example 4, properties of the heat-shrinkable tube were evaluated by using a polyvinyl chloride-based heat-shrinkable tube (commodity name: HISHI TUBE GT-51 manufactured by Mitsubishi Plastics, Inc., a folded diameter of 59 mm, a thickness of 0.1 mm). The results are shown in Table 1.

TABLE 1

| | | | Examples | | | | | | | | |
|---|---|---|---|---|---|---|---|---|---|---|---|
| | | | 1 | 2 | 3 | 4 | 5 | 6 | 7 | 8 | 9 |
| Resin composition | PPS | PPS1 | 93 | 85 | 83 | 80 | 79 | 83 | 83 | 75 | 70 |
| | (mass %) | PPS2 | — | — | — | — | — | — | — | — | — |
| | Other resins | Resin 1 | — | — | — | — | — | — | — | 9 | — |
| | (mass %) | Resin 2 | — | — | — | — | — | — | — | — | 14 |
| | Elastomer | ESM1 | — | 10 | 10 | 10 | 14 | — | — | 9 | 9 |
| | (mass %) | ESM2 | — | — | — | — | — | 10 | — | — | — |
| | | ESM3 | — | — | — | — | — | — | 10 | — | — |
| | Plasticizer | PLZ1 | 7 | 5 | 7 | 10 | 7 | 7 | 7 | 7 | 7 |
| | (mass %) | | | | | | | | | | |

| Elongation | | Longitudinal direction | 1.7 | 1.7 | 1.7 | 1.7 | 1.7 | 1.7 | 1.7 | 1.7 | 1.7 |
|---|---|---|---|---|---|---|---|---|---|---|---|
| magnification | | Diameter direction | 1.1 | 1.1 | 1.1 | 1.1 | 1.1 | 1.1 | 1.1 | 1.1 | 1.1 |
| Tan δ peak temperature (° C.) | | | 80 | 87 | 82 | 70 | 80 | 80 | 82 | 78 | 88 |
| Shrinkage | 80° C. | Longitudinal direction | 4.5 | 0.5 | 4.5 | 6.0 | 6.5 | 5.5 | 8.7 | 9.8 | 0.5 |
| ratio (%) | | Diameter direction | 43.8 | 15.7 | 41.8 | 37.4 | 38.4 | 41.1 | 39.3 | 38.2 | 19.5 |
| | 90° C. | Longitudinal direction | 6.0 | 2.8 | 5.5 | 7.7 | 6.8 | 7.2 | 11.5 | 10.7 | 4.5 |
| | | Diameter direction | 46.9 | 42.9 | 44.9 | 39.8 | 40.2 | 42.7 | 41.0 | 39.9 | 40.9 |
| | 100° C. | Longitudinal direction | 6.3 | 4.5 | 6.3 | 10.3 | 7.8 | 6.8 | 11.5 | 11.5 | 5.7 |
| | | Diameter direction | 47.5 | 45.3 | 43.1 | 38.9 | 38.9 | 41.6 | 38.7 | 38.8 | 43.1 |

| | | | | | | | | | |
|---|---|---|---|---|---|---|---|---|---|
| Flame retardancy | VW-1 | VW-1 | VW-1 | VW-1 | VW-1 | VW-1 | VW-1 | VW-1 | VW-1 |
| Thermal resistance | ∘ | ∘ | ∘ | ∘ | ∘ | ∘ | ∘ | ∘ | ∘ |

| | | | Examples | Comparative examples | | | | Reference |
|---|---|---|---|---|---|---|---|---|
| | | | 10 | 1 | 2 | 3 | 4 | example |
| Resin composition | PPS | PPS1 | — | 90 | 100 | PET | PVC | 75 |
| | (mass %) | PPS2 | 85 | — | — | | | — |
| | Other resins | Resin 1 | — | — | — | | | — |
| | (mass %) | Resin 2 | — | — | — | | | — |
| | Elastomer | ESM1 | 9 | 10 | — | | | 8 |
| | (mass %) | ESM2 | — | — | — | | | — |
| | | ESM3 | — | — | — | | | — |
| | Plasticizer | PLZ1 | 6 | — | — | | | 17 |
| | (mass %) | | | | | | | |

| Elongation | | Longitudinal direction | 1.7 | 1.7 | 1.7 | 1.7 | 1.7 | Film making |
|---|---|---|---|---|---|---|---|---|
| magnification | | Diameter direction | 1.1 | 1.1 | 1.1 | 1.1 | 1.1 | could not |
| Tan δ peak temperature (° C.) | | | 80 | 100 | 100 | 86 | 78 | be completed. |
| Shrinkage | 80° C. | Longitudinal direction | 8.5 | 0.0 | 0.2 | 2.3 | 11.2 | |
| ratio (%) | | Diameter direction | 32.6 | 0.1 | 0.3 | 33.3 | 47.3 | |
| | 90° C. | Longitudinal direction | 12.2 | 0.5 | 0.3 | 3.7 | 12.0 | |
| | | Diameter direction | 38.3 | 6.4 | 6.7 | 39.1 | 49.4 | |
| | 100° C. | Longitudinal direction | 12.5 | 6.5 | 7.8 | 4.3 | 14.0 | |
| | | Diameter direction | 38.5 | 44.0 | 42.9 | 40.1 | 50.1 | |

| | | | | | |
|---|---|---|---|---|---|
| Flame retardancy | VW-1 | VW-1 | VW-1 | — | VW-1 |
| Thermal resistance | ∘ | ∘ | ∘ | ∘ | x |

According to Table 1, since the tubes of the present invention (Examples 1 to 10) exhibit thermal resistance and flame retardancy, and the tan δ peak thereof exists within the temperature range between 65-95° C., it is understood that the heat-shrinkage ratio in both the longitudinal direction and the diameter direction is desirable in hot water of 80° C., 90° C., and boiling water. Whereas, although the heat-shrinkable tubes which do not contain plasticizer (Comparative examples 1 and 2) show thermal resistance and flame retardancy, heat-shrinkage ratio in hot water of 80° C. and 90° C. is low; thereby sufficient low-temperature shrinkable properties cannot be obtained. For heat-shrinkable tubes produced by materials other than PPS-based resin (Comparative examples 3 and 4), it is understood that propertieslike flame retardancy and thermal resistance cannot be obtained. In addition, in view of the Reference example, when adding excessive plasticizer, the tube was ruptured during elongation step so that film making could not be completed.

Accordingly, by using the resin composition of the present invention, a heat-shrinkable member (heat-shrinkable tube) can be provided which exhibits excellent flame retardancy, thermal resistance, and shrinkage property at low temperature.

### INDUSTRIAL APPLICABILITY

The resin composition of the present invention exhibits excellent shrinkage property at low temperature when forming into a heat-shrinkable member so that it can be suitably used as a heat-shrinkable member for covering electronic parts, particularly capacitor like aluminum electrolytic capacitor, as well as primary battery and secondary battery.

The entire contents of specification, claims, drawings, and abstract of Japanese patent application No. 2007-067342 which has a filing date of Mar. 15, 2007 is hereby incorporated by reference.

The terms and expressions used in the present specification and the scope of claims are merely for the sake of the explanation made herein, and the present invention is not limited thereto. Those skilled in the art will readily recognize additional numerous adaptations and modifications which can be made to the present invention which fall within the scope of the invention as claimed in the claims. Moreover, it is intended that the scope of the present invention include all foreseeable equivalents to the structures as described with reference to the drawings. Accordingly, the invention is to be limited only by the scope of the claims and their equivalents.

1. A resin composition used for a heat-shrinkable member, which comprises: at least one plasticizer; and a polyphenylene sulfide resin (a), wherein the composition has
at least one tan δ peak existing within the temperature range between 65 and 95° C. as measured by dynamic viscoelasticity at an oscillation frequency of 10 Hz, a strain of 0.1%, and a temperature increase rate of 3° C./min.

2. The resin composition according to claim 1, wherein said at least one plasticizer is a flame-retardant plasticizer.

3. The resin composition according to claim 1, wherein said at least one plasticizer is a phosphorus-based plasticizer.

4. The resin composition according to claim 1, wherein a content ratio of said at least one plasticizer to the total mass of the resin composition is 0.5 mass % or more and 15 mass % or less.

5. The resin composition according to claim 1, further comprising at least one of a resin (b) other than the polyphenylene sulfide resin (a), or a thermoplastic elastomer (c),
wherein the content ratio of the at least one of the resin (b) or the thermoplastic elastomer (c), to the total mass of the resin composition, is 0.1 mass % or more and 35 mass % or less.

6. A heat-shrinkable tube comprising the resin composition according to claim 1.

7. The heat-shrinkable tube according to claim 6, wherein a shrinkage ratio in the longitudinal direction is 20% or less and a shrinkage ratio in the diameter direction is 10% or more and 60% or less as measured after immersing the tube in water having a temperature of 90° C. for 5 seconds.

8. The heat-shrinkable tube according to claim 6, wherein a shrinkage ratio in the longitudinal direction is 15% or less and a shrinkage ratio in the diameter direction is 10% or more and 60% or less as measured after immersing the tube in water having a temperature of 80° C. for 5 seconds.

9. A member, which is covered by the heat-shrinkable tube according to claim 6.

10. The member according to claim 9, which is used for electronic devices or electric appliances.
